(19) United States
(12) Patent Application Publication
(10) Pub. No.: US 2023/0401586 A1
(43) Pub. Date: Dec. 14, 2023

(54) ITEM WITH ENGRAVING ASSOCIABLE WITH A WEB CONTENT AND METHOD FOR ACCESSING WEB CONTENT ASSOCIATED WITH AN ITEM THROUGH CODES ENGRAVED ON THE ITEM

(71) Applicant: Sergio GIUDICI, Ponte Lambro, Como (IT)

(72) Inventor: Sergio GIUDICI, Ponte Lambro, Como (IT)

(21) Appl. No.: 18/251,115

(22) PCT Filed: Oct. 27, 2021
(86) PCT No.: PCT/IB2021/059932

§ 371 Date: Apr. 28, 2023

(30) Foreign Application Priority Data
Oct. 29, 2020 (IT) 102020000025705
Oct. 29, 2020 (IT) 202020000006049
Jul. 28, 2021 (IT) 102021000020129

(51) Int. Cl. G06Q 30/018; G04B 45/00; B44C 1/22; A44C 15/00

(52) U.S. Cl. CPC G06Q 30/0185; G04B 45/0084; B44C 1/228; A44C 15/004

(57) ABSTRACT

An item with engraving associable with a web content includes an item body, made of metal or metal alloy, and at least one engraving made on the body of the item, or on an element embedded or mounted in the item body. The at least one engraving represents at least one respective code which is associated with the item and is also associated with a web connection able to show a web content, related to the item. The item includes a ring and/or a piece of jewelry and/or a jewel and/or a watch and/or a medal and/or an item made of a precious metal. The at least one engraved code includes a QR-code and/or an alphanumerical code and/or a bar code.

### FIELD OF APPLICATION

The present invention relates to an item with engraving associable with a web content.

The present invention further relates to a method for accessing web contents associated with an item through codes engraved on the item.

In particular, the present invention relates to jewelry items and watches, items made of precious metals with features that enable them to perform advanced functionalities through internet or web connections.

### DESCRIPTION OF THE PRIOR ART

Within the field of jewelry and watches and of manufacturing and use of precious items (for example, made of precious metals) methods are known which are adapted to verify the authenticity or identity of the item, and/or information on the warranty or property of the item, for example through the use of identifiers of the item which are provided to the owner. Such identifiers are physically completely unrelated to the item, just as the electronic media (e.g., online databases or software programs) which can be used for verifying the aforesaid information are completely independent from the item, which can lead to various drawbacks in terms of the ease of practical use by the user and/or speed and reliability of the responses obtained.

Therefore, within the technical field considered there is a strong need for solutions to improve the aforesaid methods for verifying the authenticity or identity or ownership of the item, or for finding information on such product.

### SUMMARY OF THE INVENTION

It is the object of the present invention to provide an item (for example a precious object) which is structurally and functionally improved so as to allow at least partially obviating the drawbacks mentioned above with reference to the known art, and responding to the aforementioned needs particularly felt in the technical field considered. Such an object is achieved by means of a ring or jewel assembly according to claim 1.

Further embodiments of such a ring or jewel assembly are defined in claims 2-20.

It is also an object of the present invention to provide a method for accessing web contents associated with an item (for example a precious object), which allows at least partially obviating the drawbacks mentioned above with reference to the known art, and responding to the aforementioned needs particularly felt in the technical field considered. Such an object is achieved by a method according to claim 21.

Further embodiments of such a method are defined in claims 22-24.

### BRIEF DESCRIPTION OF THE DRAWINGS

Further features and advantages of the method according to the invention will be apparent in the following description which illustrates preferred embodiments, given by way of indicative, non-limiting examples, with reference to the accompanying figures, in which:

FIGS. 1A, 1B, 10 illustrate axonometric and perspective views of an item (in particular, a ring) according to an embodiment of the present invention;

FIGS. 2A, 2B and 2C illustrate axonometric and perspective views of another item (in particular, a watch) according to another embodiment of the present invention;

FIGS. 3A, 3B and 3C illustrate axonometric and perspective views of another item (in particular, another ring) according to another embodiment of the present invention.

### DETAILED DESCRIPTION

With reference in particular to the aforesaid figures, an item 1 with engraving associable with a web content is described.

Such item 1 comprises an item body 2, made of metal or metal alloy, and at least one engraving made on the aforesaid item body, or made on an element 5 embedded or mounted in the item body.

The aforesaid at least one engraving represents at least one respective code 3, 4 which is associated with the item and is also associated with a web connection able to show a web content, related to the item.

The aforesaid item 1 comprises a ring and/or a piece of jewelry and/or a jewel and/or a watch and/or a medal and/or an item made of a precious metal or precious metal alloy.

The aforesaid at least one engraved code comprises a QR-code 3 and/or an alphanumerical code 4 and/or a numerical code 4 and/or a bar code and/or a DATAMATRIX code.

According to a preferred implementation option, the aforesaid at least one engraved code is a OR-code 3, which can be framed by a mobile user device.

According to another implementation option, the aforesaid at least one engraved code is an alphanumerical or numerical code 4, readable when looking at the item, and which can be entered by a user interface into a desktop or laptop computer or processor or associated with a mobile device.

According to another implementation option, the aforesaid at least one engraved code is a bar code, readable by a bar code reader.

According to an embodiment, the aforesaid at least one engraving is made on a metal (e.g., gold or silver or aluminum or iron) or metal alloy (e.g., steel) portion of the item body.

According to an implementation option of such an embodiment, the aforesaid at least one engraving is made on the metal by means of laser engraving.

According to different possible implementation options, the aforesaid engraving is made by means of laser engraving machines known in themselves, calibrated in a way depending on the metal type.

According to an implementation option, which the Applicant has verified to be able to make engravings of readable codes and/or QR Codes recognizable by framing with a smartphone, with engraving depth and spatial resolution suitable for this purpose, the aforesaid engraving is made by a “Sisma”® branded laser engraving machine model “BSS-3d stand alone”® or “BSP stand alone” ® or “BSP pico stand alone”® or “LWS-M”® or “LWS-A”®, or model “Big Smark”.

The setting parameters of the laser machine depend on the hardness of the metal used, i.e., gold, or precious metals used in the jewelry world, and steels used in the watchmaking world, and can be established in a known way, on the basis of the knowledge of the specifications and performance of the laser machine used and the metal on which the engraving is to be made.

According to another embodiment, the aforesaid at least one engraving is made on an element 5 that is mounted or embedded or recessed in cavity or recess 6 obtained in the item body.

According to an implementation option, the aforesaid element 5 is a plate 5 made of steel or metal.

According to another implementation option, the aforesaid element 5 is a plate 5 made of ceramic.

According to an implementation option, the aforesaid element 5 is a stone or precious stone.

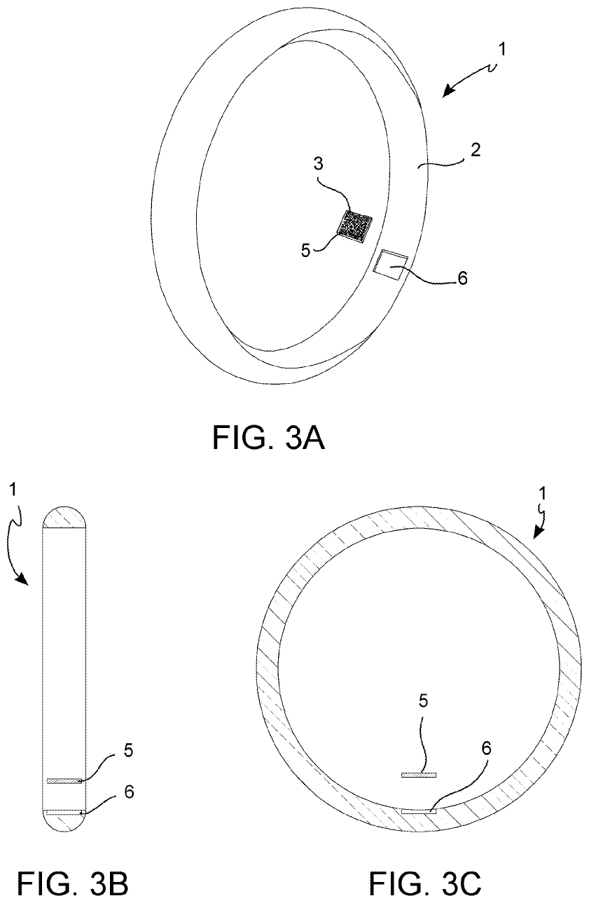

According to an implementation option (that is illustrated in FIG. 3) the aforesaid cavity 6, which contains the element on which the code is engraved, is obtained on an internal portion of a ring.

According to another implementation option, the aforesaid cavity 6, which contains the element on which the code is engraved, is obtained on an external portion of a ring.

According to an embodiment of the item, the aforesaid web connection associated with the engraved code is a URL link which enables to access a web portal and/or a web page through which the aforesaid contents associated with the item are visible.

According to an implementation option, the web link or electronic connection is associated with the two-dimensional representation of the QR Code according to manners known per se.

According to an implementation option, the aforesaid access to the web portal, in which the web contents associated with the item are stored and through which they are visible, enable further item verification and authentication functions to be carried out, which will be described in more detail below.

According to an embodiment, the aforesaid code associated with the item is a unique item identifier.

In such a case, the aforesaid web content reachable through the web connection associable with the code comprises information relating to the recognition and/or authentication and/or characterization of the item.

According to different possible embodiments, the aforesaid information relating to the recognition and/or authentication and/or characterization of the item comprises pieces of information adapted to verify one or more of the following functions:
authenticity of the item, and/or
technical features of the item, and/or
duration of the warranty of the item, and/or
indication of the ownership of the item and/or history of the ownership of the item, and/or
tracking of service/maintenance interventions, and/or
immediate reporting of theft or loss of the item, and/or
geolocation of the closest retailer.

According to an implementation option, the aforesaid information relating to the recognition and/or authentication and/or characterization of the item comprises photographs and/or videos and/or audios of the item (possibly, also in addition to the other pieces of information mentioned above).

In accordance with another embodiment, the aforesaid information relating to the recognition and/or authentication and/or characterization of the item comprises traceability information that can be generated and/or accessed by the manufacturer.

According to different implementation options, the aforesaid traceability information comprises:
item traceability information along the production chain, and/or
logistics control information for distribution, and/or
customer database creation information, and/or
information for checking the expiry of the warranty and any extensions, and/or
information relating to a list of maintenance interventions, and/or
information for checking the sales of authorized retailers, and/or
information for checking the authenticity of the items by the retailers, and/or
information relating to the impossibility to counterfeit the item and the warranty, and/or
information relating to the history of the ownership of the item, and/or
information on receiving reports of theft or loss, and/or
information relating to the loading of photographs and videos of the item.

According to another embodiment, the aforesaid web content reachable through the web connection associated with the code comprises contents loadable by a user (in particular, by the owner or the user or the manufacturer of the item).

According to different possible embodiments, such contents loadable by a user comprise photographic and/or video and/or audio contents.

According to an embodiment, the item is a ring or piece of jewelry or jewel, and the aforesaid photographic and/or video and/or audio contents comprise photograph albums and/or digital videos of events and/or ceremonies.

Different implementation options envisage every possible combination between ring or piece of jewelry or jewel and associated contents (photograph albums and/or digital videos of events and/or ceremonies).

For example, the ceremonies may be weddings (wherein the item is for example a wedding ring) and/or engagements (wherein the item is for example an engagement ring), and/or baptisms, or the like.

According to an embodiment, the item is a prize ring and/or a prize medal, or another precious item for a prize-giving, and the aforesaid photographic and/or video and/or audio contents comprise images and/or videos of a sports and/or cinematographic and/or musical event and/or another type of event, and/or of the related prize-giving.

According to an embodiment, the item comprises at least two engravings corresponding to at least two respective codes, including at least one QR-code and at least one numerical or alphanumerical or bar code.

According to an implementation option of such embodiment, the aforesaid QR-code and the aforesaid numerical or alphanumerical code are codes associated with one another and both corresponding to the item.

Such codes can for example be generated by the web portal or website which is then also used for accessing the item data.

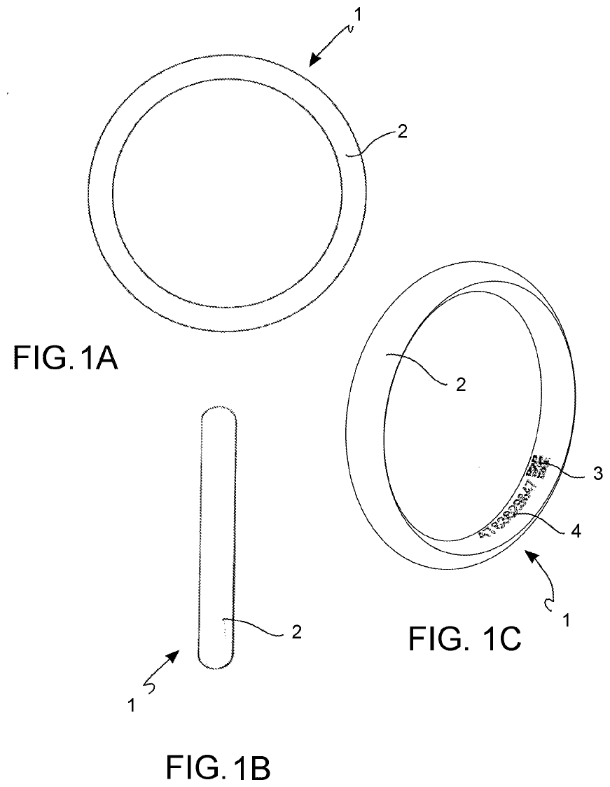

According to an embodiment (illustrated in FIG. 1, in which FIG. 1A is a view from above, FIG. 1B is a side view, FIG. 1C is an axonometric view), the item is a ring, wherein the engraving corresponding to the code is made on the inner surface of the ring.

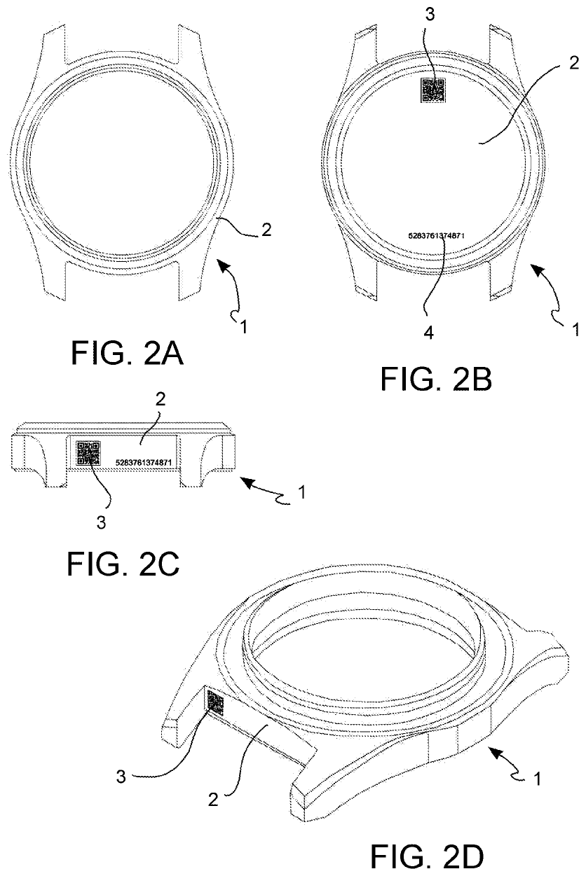

According to another embodiment (illustrated in FIG. 2, in which FIG. 2A is a view from above, FIG. 2B is a view from below, FIG. 2C is a side view, FIG. 2D is an axonometric view), the item is a watch, the engraving corresponding to the code is made on the case or the back or the clock face or on an external part or on gears.

According to another embodiment (illustrated in FIG. 3 by “exploded” views, in which FIG. 3A is an axonometric view, FIG. 3B is a side view, FIG. 3C is a view from above), FIG. 2B is a view from below, FIG. 2D is, the item is a ring, the engraving corresponding to the code is made on a plate 5 to be mounted in the cavity 6, which, in this example, is obtained on the inner part of the ring. In the aforesaid “exploded” views, the plate on which the code is engraved is shown outside the cavity, for the purpose of illustration clarity, but obviously, in the finished item to which this disclosure refers, it is actually inserted or mounted in the cavity.

According to another embodiment, the item is a piece of jewelry, in which the engraving corresponding to the code is made on an upper part or on a lower part of the piece of jewelry.

A method for accessing web contents associated with an item 1 through codes 3, 4 engraved on the item is now described.

Such method comprises the steps of making, via laser engraving, at least one engraving on an item body 2, made of metal or metal alloy, or on an element 5 embedded or mounted in the item body, wherein the aforesaid at least one engraving represents at least one respective code 3, 4, which is associated with the metal item and is further associated with a web connection able to show the aforesaid web content, related to the item.

The aforesaid item 1 comprises a ring and/or a piece of jewelry and/or a jewel and/or a watch and/or a medal and/or is an item made of a precious metal or precious metal alloy.

The aforesaid at least one engraved code comprises a QR-code 3 and/or a numerical code 4 and/or an alphanumerical code 4 and/or a bar code.

According to an implementation option, the aforesaid step of making at least one engraving on an item body 2 is performed by a manufacturer of the item.

According to an embodiment, the method comprises the further steps of accessing a web portal through an electronic link, associated with the aforesaid code engraved onto the item, to the web portal; and then accessing description and/or characterization information of the item comprising photographs and/or videos and/or a written description of technical features of the item.

In that case, the aforesaid step of accessing a web portal comprises accessing the web portal through the acquisition of the image of the OR Code through a mobile user device, for example a smartphone (according to an implementation option); or, accessing the web portal by entering the numerical or alphanumerical engraved code by means of a processor or desktop or laptop computer (according to another implementation option).

According to an embodiment, the method comprises the further step of accessing, through the web portal, further authentication and/or anti-counterfeiting and/or warranty verification, by the user and owner of the item, through the aforesaid web portal, by entering a further user code available to the user of the item and provided by the manufacturer. According to an implementation example, such further code may be generated by the portal which the user can access.

According to different possible implementation options, the method further comprises the step of performing, by the user of the item, through the aforesaid web portal, by entering the aforesaid further user code available to the owner of the item, one or more of the following functions:
reporting of theft or loss of the item; and/or
item maintenance interventions; and/or
access to the item ownership history.

A further embodiment of the method, illustrated by way of non-limiting example, is described herein below, with some further details.

In such embodiment, the web portal (or web page or website) is reached directly by the acquisition of an image of the QR code, engraved onto the item, by means of a smartphone provided with a camera and provided with a software program configured to recognize the QR code, derive the corresponding web link and implement a connection with the corresponding web portal or page, and view the contents of such web portal or page on the smartphone.

The user can also access the web portal or page by typing into the user interface of the smartphone (or a PC or other processing device of the user) an alphanumerical or numerical code.

Such code can for example be a numerical code of 10 numbers, implemented, for example, by a TIMESTAMP procedure and convertible into a corresponding two-dimensional QR-code (both codes can be generated by the web portal).

Through the aforesaid access, the user can access photographic data relating to the item 1, and/or technical features and description of the item or product.

In a subsequent step, reserved for example for the owner of the item and/or the manufacturer, access to reserved data protected by a further level of security (known to the owner and not directly obtainable from the item) is guaranteed, through one or two further codes (for example, further numerical codes of 10 figures, generated with the TIMESTAMP system still from the portal).

Such “privileged” and further reserved access offers the possibility to access further information such as for example seeing who is the owner of the item, the duration of the warranty, tracking of maintenance interventions, changes of ownership.

Furthermore, following such “privileged” and furthermore reserved access, it is possible to report theft or loss, thus reporting such problem to the portal.

From the moment in which the theft or loss is reported, by the owner, by framing the QR code or entering the numerical code the portal no longer shows the technical data sheet of the product but shows a warning report to contact the closest retailer or dealer, therefore providing an indication of the fact that the item is in a problematic situation.

As can be seen, the objects of the present invention as previously indicated are fully achieved by the item and method described above by virtue of the structural and functional features shown above in detail.

In fact, the item according to the invention (for example a ring or jewel or piece of jewelry or even a medal), described above, enables Internet connection functions to be integrated, in particular to a dedicated web portal, through engraving a code on the item itself, thus determining an identifier physically and closely associated with the item itself (with consequent advantages of practical easy use by the user and/or speed and reliability of the responses obtained).

For such a purpose, the item according to the invention introduces to the jewelry field a technology for connection to a dedicated portal (for example, through the acquisition, by a smartphone, of the image of a two-dimensional QR code, or by typing a numerical code onto the keyboard of a computer or desktop).

The aforesaid codes are engraved onto the item, and are uniquely associated therewith and therefore able to identify it: such codes are actually a “license plate” of the item itself.

In this way, unlike known solutions, to the knowledge of the Applicant, for the first time in the jewelry area it is possible for the owner of the precious item to verify at any time and place the warranty, the authenticity, and furthermore images and descriptive information of his/her precious item.

Furthermore, for the first time the owner has the availability of a sort of license plate (i.e., the aforesaid codes engraved into the item and such as to enable access to a web portal) which further enables the reporting of theft or loss, also so as to facilitate the police in tracing ownership.

Additionally, as the precious items to which the idea is applicable are very diverse (for example rings and/or pieces of jewelry and/or jewels and/or watches and/or prize medals, and so on), the idea has been developed (as previously illustrated) so as to be usefully applied in a wide range of areas and contexts enabling further advantages such as, for example, easy access to contents connected with ceremonies or events related to the item (for example, to a photograph album of a wedding, if the item is a wedding ring; or to images or videos of a sports competition or a sports award ceremony, if the item is a prize medal or ring; and so on). A person skilled in the art will easily understand, on the basis of the description provided above, how the invention can be advantageously used in a wide plurality of applications.

A person skilled in the art may make changes and adaptations to the embodiments of the assembly described above or can replace elements with others which are functionally equivalent to satisfy contingent needs without departing from the scope of protection of the appended claims. Each of the features described as belonging to a possible embodiment can be achieved irrespective of the other embodiments described.

1. An item with engraving associable with a web content, comprising:
an item body, made of metal or metal alloy;
at least one engraving made on said item body or on an element embedded or mounted in the item body, wherein said at least one engraving represents at least one respective engraved code which is associated with the item and is also associated with a web connection able to show a web content, related to the item;
wherein said item comprises a ring and/or a piece of jewelry and/or a jewel and/or a watch and/or a medal and/or an item made of a precious metal or of a precious metal alloy;
and wherein said at least one engraved code comprises a QR-code and/or a numerical code and/or an alphanumerical code and/or a bar code and/or a QR DATAMATRIX code.

2. An item according to claim 1, wherein said at least one engraved code is a QR-code, which is frameable by a mobile user device.

3. An item according to claim 1, wherein said at least one engraving is made on a metal or metal alloy portion of the item body.

4. An item according to claim 3, wherein the item body is made of gold and/or silver and/or aluminum and/or steel.

5. An item according to claim 3, wherein said at least one engraving comprises laser engraving.

6. An item according to claim 1, wherein said at least one engraving is made on an element that is mounted or embedded or recessed in cavity obtained in the item body.

7. An item according to claim 6, wherein said element is a plate made of steel or metal, or wherein said element is a plate made of ceramic.

8. (canceled)

9. An item according to claim 6, wherein said element is a stone or precious stone.

10. An item according to claim 1, wherein said web connection associated with the engraved code is a URL link which enables access to a web portal and/or a web page through which said contents associated with the item are visible.

11. An item according to claim 1, wherein said code associated with the item is a unique identifier of the item, and wherein said web content reachable through the web connection associated with the code comprises information relating to recognition and/or authentication and/or characterization of the item.

12. An item according to claim 11, wherein said information relating to the recognition and/or authentication and/or characterization of the item comprises pieces of information adapted to verify the following functions:
authenticity of the item and/or technical features of the item and/or duration of the warranty of the item and/or ownership of the item and/or history of the ownership of the item and/or service/maintenance interventions and/or immediate reporting of theft or loss and/or geolocation of the closest retailer, and/or wherein said information relating to the recognition and/or authentication and/or characterization of the item comprises photographs and/or videos of the item.

13. (canceled)

14. An item according to claim 11, wherein said information relating to the recognition and/or authentication and/or characterization of the item comprises traceability information that is generated and/or accessed by the manufacturer, said traceability information comprising:
pieces of information about traceability of the item along a production chain and/or about distribution logistics control and/or about creation of customer databases and/or about checking expiry of the warranty and any extensions and/or about list of maintenance interventions and/or about checking sales of authorized retailers and/or checking authenticity of the items by retailers and/or about impossibility to counterfeit the item and the warranty and/or about history of ownership of the item and/or about receipt of reporting of theft or loss and/or about loading photographs and videos and/or audios of the item.

15. An item according to claim 1, wherein said web content reachable through the web connection associated with the code comprises photographic and/or video and/or audio contents loadable by a user.

16. An item according to claim 15, wherein the item is a ring or piece of jewelry or jewel, and said photographic and/or video and/or audio contents comprise photograph albums and/or digital videos of events and/or ceremonies, or wherein the item is a ring and/or a medal and/or another precious item for a prize-giving, and said photographic and/or video and/or audio contents comprise images and/or videos of a sports and/or cinematographic and/or musical event and/or of the related prize-giving.

17. (canceled)

18. An item according to claim 1, comprising at least two engravings corresponding to at least two respective codes, including at least one QR-code and at least one numerical or alphanumerical code, wherein said QR-code and said numerical or alphanumerical code are codes associated with each other and both corresponding to the item.

19. (canceled)

20. An item according to claim 1, wherein:
the item is a ring, wherein the engraving corresponding to the code is made on an inner surface of the ring; or
the item is a watch, wherein the engraving corresponding to the code is made on a case or back or clock face or on an external part or on gears; or
the item is a piece of jewelry, in which the engraving corresponding to the code is made on an upper part or on a lower or on a lateral part of the piece of jewelry.

21. A method for accessing web contents associated with an item through codes engraved on the item, comprising:
making, via laser engraving, at least one engraving on an item body, made of metal or metal alloy, or on an element embedded or mounted in the item body, wherein said at least one engraving represents at least one respective engraved code associated with the metal item and further associated with a web connection able to show said web content, related to the item;
wherein said item comprises a ring and/or a piece of jewelry and/or a jewel and/or a watch and/or a medal and/or an item made of a precious metal or of a precious metal alloy;
and wherein said at least one engraved code comprises a QR-code and/or a numerical code and/or an alphanumerical code and/or a bar code and/or a DATAMATRIX code.

22. A method according to claim 21, comprising the further steps of:
accessing a web portal through an electronic link to the web portal, associated with said code engraved onto the item;
accessing information describing and/or characterizing the item comprising photographs and/or videos and/or a written description of technical features of the item;
wherein said step of accessing a web portal comprises accessing the web portal through acquisition of the image of the QR Code through a mobile user device, or by entering the numerical or alphanumerical code engraved by a processor or desktop or laptop computer.

23. A method according to claim 22, comprising the further step of:
accessing, through the web portal, further authentication and/or anti-counterfeiting and/or warranty verification information, by a user and owner of the item, through said web portal, by entering one or more further user codes available to the user of the item.

24. The method according to claim 23, further comprising the step of performing, by the user of the item, through said web portal, by entering said further user code available to the owner of the item, one or more of the following functions: reporting of theft or loss of the item; item maintenance interventions; access to the item ownership history.
